(19) United States
(12) Patent Application Publication
(10) Pub. No.: US 2022/0102746 A1
(43) Pub. Date: Mar. 31, 2022

(54) FUEL CELLS WITH ENHANCED CARBON MONOXIDE TOLERANCE CATALYST LAYER USING COMPOSITE CATALYST

(71) Applicant: HYZON MOTORS INC., Honeoye Falls, NY (US)

(72) Inventors: Rajesh Bashyam, Delta (CA); Zhai Jun, Shanghai (CN)

(21) Appl. No.: 17/482,585

(22) Filed: Sep. 23, 2021

Related U.S. Application Data
(60) Provisional application No. 63/084,380, filed on Sep. 28, 2020.

(51) Int. Cl. H01M 8/1004; H01M 4/90; H01M 4/92

(52) U.S. Cl. CPC H01M 8/1004; H01M 4/926; H01M 4/9016

(57) ABSTRACT

A membrane electrode assembly (MEA) includes a membrane, a cathode catalyst layer, and an anode catalyst layer. The anode catalyst layer includes a Pt/C catalyst layer that has one or more hydrogen bronzes. The hydrogen bronzes include one or more oxides of niobium, molybdenum, and tungsten. The anode catalyst layer does not include ruthenium.

### CROSS-REFERENCE TO RELATED APPLICATIONS

This application claims the benefit of U.S. Provisional Application Ser. No. 63/084,380, filed on Sep. 28, 2020. The entire disclosure of the above application is hereby incorporated herein by reference.

### FIELD

The present disclosure relates generally to fuel cells, and more particularly, to fuel cells having a membrane electrode assembly including a composite catalyst layer with enhanced carbon monoxide (CO) tolerance.

### INTRODUCTION

This section provides background information related to the present disclosure which is not necessarily prior art.

A fuel cell has been proposed as a clean, efficient, and environmentally responsible power source for various industries, including manufacturing centers, homes, and electric vehicles among other applications.

One example of the fuel cell is a proton exchange membrane (PEM) fuel cell. The PEM fuel cell includes a membrane electrode assembly (MEA) having a thin, solid polymer or composite membrane having anode and cathode layers (including a catalyst) disposed on opposite faces of the membrane. The membrane can include an ionomer and can be permeable to protons. The MEA can be disposed between a pair of porous conductive materials, also known as gas diffusion media, which distribute gaseous reactants, for example, hydrogen to the anode layer and oxygen or air to the cathode layer. The hydrogen reactant is introduced at the anode where it reacts electrochemically in the presence of the catalyst to produce electrons and protons. The electrons are conducted from the anode to the cathode through an electrical circuit disposed therebetween, which can include an electrical load such as an electric motor, for example. Simultaneously, the protons pass through the membrane to the cathode where an oxidant, such as oxygen or air, reacts electrochemically in the presence of the catalyst to produce oxygen anions. The oxygen anions react with the protons to form water as a reaction product.

The MEA of the PEM fuel cell is sandwiched between a pair of electrically conductive bipolar plates which serve as current collectors for the anode and cathode layers. The bipolar plates can contain and direct fluids into, within, and out of the fuel cell, and distribute fluids (e.g., reactant fluids including hydrogen and oxygen or air, coolant) to fuel cell areas necessary for operation. Also, bipolar plates can provide structural support for diffusion media, membranes, seals, etc. Additional functions of bipolar plates can include sealing between fuel cells in a fuel cell stack, conducting heat formed by reactions within the fuel cell, and importantly conducting electricity generated by the fuel cell reactions.

While fuel cell technology is still developing, and there are numerous key areas in which fuel cell technology can improve relating to fuel cell efficiency, lifespan, and manufacturing costs. Various aspects of the membrane electrode assembly can impact the overall durability and longevity of a fuel cell. The catalyst layers, that assist the oxidation and reduction reactions that take place at the anode and the cathode, can play an important role in how efficiently a fuel cell operates. Precious metals, and in particular platinum, have been found to be efficient and stable electrocatalysts for fuel cells operating at temperatures below 300° C. The platinum electrocatalyst is typically provided as very small particles (˜2-5 nm) having high surface area, which are often, but not always, distributed on and supported by larger macroscopic electrically conductive particles to provide a desired loading of catalyst. Conducting carbon particles can be used to support the catalyst. More specifically, certain fuel cells can employ a loading target of platinum-group metals between about 0.025 mg/cm² Pt and 0.1 mg/cm² Pt for the anode. However, at low noble-group metal loading levels, there can be increased carbon monoxide (CO) absorption that can lead to corrosion and degradation of the anode and cathode, thereby resulting in an overall shorter lifespan of the fuel cell.

An additional problem relates to purity of the hydrogen fuel (H₂), where contaminants present therein can provide a source of CO absorption. This can be especially problematic for fuel cells that are used in technologies with very specific industry targets and requirements, for example, in the automotive industry. it has been found that even trace amounts of impurities present in either the fuel or air streams may poison the anode, cathode, and membrane—particularly at low temperature operation (e.g., <100° C.). Poisoning of any one of these components can result in a performance drop of the MEA.

A variety of known platinum-based catalysts can exhibit enhanced CO tolerance. For example, catalysts based on platinum and ruthenium deposited on carbon (PtRu/C) can have enhanced CO tolerance compared to catalysts based on platinum alone deposited on carbon (Pt/C). However, there are certain disadvantages associated with PtRu/C based catalysts. Ruthenium dissolution and subsequent crossover from the anode to the cathode, for example, can negatively impact the durability and longevity of the fuel cell over time.

Accordingly, there is a continuing need for a membrane electrode assembly with enhanced CO tolerance that is durable and has an improved lifespan. Desirably, improvements in technology related to the membrane electrode assembly would not result in fuel cells that are overly complex or costly to manufacture.

### SUMMARY

In concordance with the instant disclosure, a membrane electrode assembly with enhanced CO tolerance that is durable, has an improved lifespan, and is not overly complex or costly to manufacture, has been surprisingly discovered.

In one embodiment, a membrane electrode assembly (MEA) is provided that includes a membrane, a cathode catalyst layer, and an anode catalyst layer. The anode catalyst layer includes a Pt/C catalyst layer that includes hydrogen bronzes. The hydrogen bronzes include one or more oxides of niobium, molybdenum, and tungsten. In certain embodiments, the anode catalyst layer of the MEA does not include ruthenium.

In another embodiment, a membrane electrode assembly (MEA) is provided that includes a membrane, a cathode catalyst layer, and an anode catalyst layer. The anode catalyst layer includes at least one of Pt/C—H—NbO₅, Pt/C—H—MoO₃, and Pt/C—H—WO₃. In certain embodiments, the anode catalyst layer does not include ruthenium.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 illustrates a schematic, exploded perspective view of a PEM fuel cell stack, showing only two fuel cells with a single bipolar plate assembly for purpose of simplicity, where each fuel cell includes a membrane electrode assembly constructed in accordance with the present technology;

FIG. 2 is a schematic, exploded perspective view of a single fuel cell of the fuel cell stack of FIG. 1, showing the membrane and anode and cathode layers of the MEA constructed in accordance with the present technology;

FIG. 3 is a schematic, partially exploded side cross-sectional view of the single fuel cell of FIG. 2, showing the membrane and anode and cathode layers of the MEA constructed in accordance with the present technology; and

FIG. 4 is a flowchart illustrating a method of forming an MEA in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

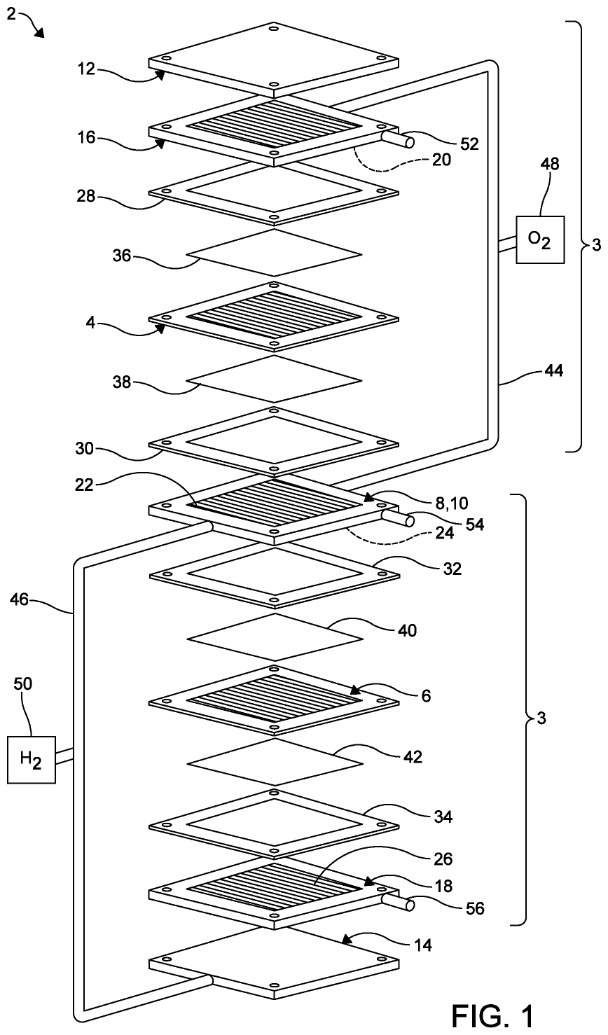

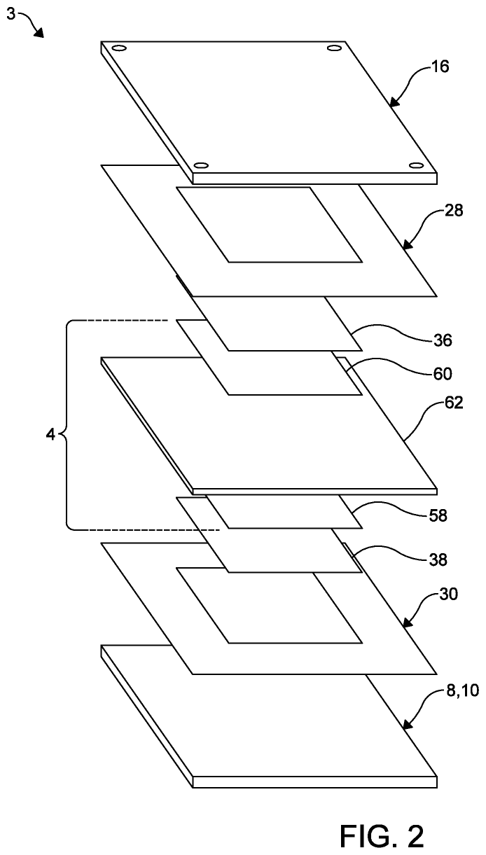

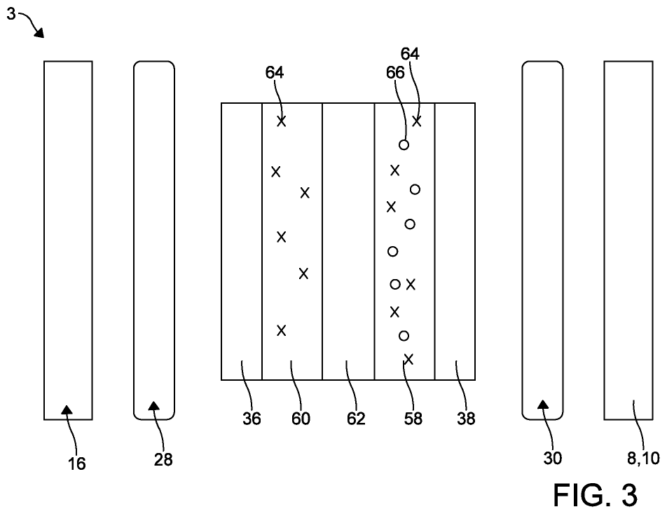

A fuel cell can include a pair of bipolar plates sandwiching a membrane electrode assembly (MEA), where certain gaskets and/or gas diffusion layers can be provided to optimize reactant distribution and localization. A non-limiting example of the general structure of a fuel cell stack including two fuel cells is shown in FIG. 1, where representations of a single fuel cell are shown in FIGS. 2-3. However, it should be appreciated that a skilled artisan can employ one or more fuel cells with different structures, within the scope of this disclosure.

The bipolar plates can be configured to surround a respective MEA and can be used to connect multiple MEAs of multiple fuel cells in series by stacking them atop or adjacent each other to provide a desired output voltage. The bipolar plates are electrically conductive and can be manufactured from metal, carbon, or composites. Each of the bipolar plates can also include a reactant flow field. The flow field can include a set of channels machined or stamped into the plate to permit reactant fluids to be distributed to the MEA. It should be appreciated that one skilled in the art can employ different bipolar plates, as desired.

Various gaskets can be disposed relative to the bipolar plates and the MEA of the fuel cell. The gaskets can be configured to provide a fluid-tight seal at certain portions of the fuel cell. The gaskets can be manufactured from an elastomer or polymer or any other material suitable for forming a fluid-tight seal. It should be appreciated that a skilled artisan can employ different gaskets, within the scope of this disclosure.

The MEA can include a membrane and electrode layers that include one or more catalysts. The electrode layers (e.g., anode layer and cathode layer) can include one or more identical or different catalysts. The membrane can include a proton exchange membrane (also referred to as a polymer electrolyte membrane), which can include one or more ionomers. The membrane can be configured to conduct protons therethrough while acting as an electric insulator and reactant fluid barrier; e.g., preventing passage of oxygen and hydrogen. It should be appreciated that one skilled in the art can select other types of membranes for the membrane, as desired. The membrane can be disposed between two catalyst layers, which can include various materials having one or more catalysts embedded therein. One of skill in the art can select other types of membranes, as desired, to be used in the MEA.

The membrane can be configured as an ion exchange resin membrane. Such ion exchange resins include ionic groups in their polymeric structure, one ionic component of which is fixed or retained by the polymeric matrix and at least one other ionic component is a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cation exchange, proton conductive resins is the so-called sulfonated polymer cation exchange resins. In the sulfonated polymer membranes, the cation ion exchange groups can include hydrated sulfonic acid radicals which are covalently attached to the polymer backbone.

Such ion exchange resins can be formed into membranes or sheets. Examples include sulfonated fluoropolymer electrolytes in which the membrane structure has ion exchange characteristics, and the polymer has a fluorinated backbone structure. Commercial examples of such sulfonated fluorinated, proton conductive membranes include membranes available from E.I. Dupont de Nemours & Co. under the trade designation NAFION. Another such sulfonated fluorinated ion exchange resin is sold by Dow Chemical.

The membrane can be disposed between at least two electrode layers including an anode layer and a cathode layer. The electrode layers can each include one or more types of catalysts, where certain embodiments can include particles of platinum (Pt) disposed on a high-surface-area carbon support (Pt/C). However, other noble group metals can also be used for the catalyst. The Pt/C can be mixed with an ion-conducting polymer (e.g., ionomer) and disposed between the membrane and the gas diffusion layers in forming the fuel cell. The anode layer enables hydrogen molecules to dissociate into protons and electrons. The cathode layer enables oxygen reduction by reacting with the protons generated by the anode, producing water. The ionomer mixed into the catalyst layers can allow the protons to travel through these layers.

In certain embodiments, the anode layer can be made from a composite of platinum, carbon support, and hydrogen bronzes or hydrogenated metal oxides. More specifically, the catalyst in the anode can be represented by the general chemical structure of Pt/C—H—MOₓ, wherein MOₓ can be a doped metal oxide. The doping of the metal oxide changes the electrical resistance of the metal oxide and enhances the catalytic properties of the metal oxide.

One or more hydrogen bronzes can be provided in the anode layer to minimize oxidation onset potential of the Pt/C and optimize tolerance of the anode to carbon monoxide (CO). The hydrogen bronzes for use in the anode catalyst layer can be integral with the anode catalyst layer or separate from the anode catalyst layer. The hydrogen bronzes can include one or more oxides of niobium, molybdenum, and/or tungsten; for example, Nb₂O₅, MoO₃, and/or WO₃. In particular, the anode catalyst layer can include Pt/C and hydrogen bronzes, as represented by Pt/C—H—MOₓ, where M can be selected from a non-limited group of metals including Nb, Mo, W, and/or doped oxides thereof, such as niobium doped tungsten oxide.

In order to form the anode layer, the anode components including the catalyst can applied directly to the membrane using any applicable method known to those of skill in the art. These methods can include, but are not limited to, decal transfer, wet impregnation, and co-precipitation. A typical wet impregnation infiltration process for the anode can include multiple iterations using a low electrocatalyst concentration in order to prevent agglomeration at the anode's surface while also depositing a sufficient amount of electrocatalyst at the cathode active layer to positively impact performance, catalysis of reactant, and catalysis of carbon monoxide to carbon dioxide. Certain alternative approaches include a one-step infiltration method by submerging a tubular fuel cell into an electrocatalyst and then heating the solution. For example, in certain embodiments, an anode including a Pt/C catalyst can be impregnated with synthesized hydrogen bronzes; e.g., HₓNb₂O₅. It should be appreciated that one skilled in the art can employ different hydrogen bronzes and use various synthesis methods, as desired. Additionally, one skilled in the art can employ one or more hydrogen bronzes at other locations in the membrane electrode assembly; e.g., the cathode layer.

The above-described anode layer, including one or more hydrogen bronzes, can significantly reduce the oxidation onset potential compared to an anode catalyst including platinum and a carbon support without hydrogen bronzes, thereby enhancing the CO tolerance at the anode. More specifically, the absorbed hydrogen on the platinum and carbon support, after dissociation, can spill over to oxide and form Hₓ—MO₃, which can include one or more of Hₓ—Nb₂O₅, Hₓ—MoO₃, and Hₓ—WO₃. This can weaken a metal-oxygen (M—O) bond (e.g., the Nb—O, Mo—O, and/or W—O bond), thereby making it more oxophilic. The oxophilic moiety can therefore provide an intermediate for CO oxidation, for example, according to the reaction: Pt—CO+HₓMoO₃—OH=Pt-MoO₃+H⁺+CO₂, thus enhancing the CO tolerance at the anode.

In certain embodiments, ruthenium is not included in the anode catalyst, i.e., the anode layer is free of ruthenium. Although CO tolerance can be improved with a PtRu/C catalyst, a disadvantage of using a platinum catalyst with a ruthenium catalyst is that ruthenium dissolution and crossover can occur through the membrane to the cathode layer and degrade performance of the cathode layer. However, the present technology can mitigate the impact of CO, can enhance CO tolerance where there is a low Pt loading level, and can improve the durability and lifespan of the MEA of the fuel cell. Advantageously, the fuel cell including the MEA described herein is not overly complex or costly to manufacture.

A gas diffusion layer (GDL) can be disposed outside of each of the electrode layers (e.g., anode layer and cathode layer) and can facilitate transport of reactant fluids to the respective electrode layer, as well as facilitate removal of reaction products, such as water. Each of the gas diffusion layers can be compromised of a sheet of carbon paper in which the carbon fibers are partially coated with polytetrafluoroethylene (PTFE). Reactant fluids such as hydrogen gas and oxygen gas or air can diffuse through the pores in the gas diffusion layers. The gas diffusion layer can be coated with a thin layer of high-surface-area carbon mixed with PTFE, which can be referred to as a microporous layer. The microporous layer can be used to tailor a desired balance between water retention (as needed to maintain membrane conductivity) and water removal (as needed to keep pores open so hydrogen and oxygen can diffuse into the respective electrodes). It should be appreciated that a person skilled in the art can select other types of gas diffusion layers, within the scope of this disclosure. It should also be appreciated that the gas diffusion layers can be incorporated into the electrode layers.

### EXAMPLES

Example embodiments of the present technology are provided with reference to the several figures enclosed herewith.

A non-limiting example of the general structure of a fuel cell stack including two fuel cells is shown in FIG. 1. However, it should be appreciated that a skilled artisan can employ fuel cells with different structures, within the scope of this disclosure.

FIG. 1 depicts a PEM fuel cell stack 2 of two fuel cells 3, each fuel cell 3 having a membrane-electrode-assembly (MEAs) 4, 6 separated from each other by an electrically conductive fluid distribution element 8, hereinafter also referred to as bipolar plate assembly 10. The MEAs 4, 6 include a membrane-electrolyte layer having an anode layer and a cathode layer, each with catalyst, on opposite faces of the membrane-electrolyte layer. The MEAs 4, 6 and bipolar plate assembly 8, 10 are stacked together between end plates 12, 14 and end contact elements 16, 18 under compression. The end contact elements 16, 18 and the bipolar plate assembly 8, 10 include working faces 20, 22, 24, 26 respectively, for distributing fuel and oxidant gases (e.g., H₂ and air or O₂) to the MEAs 4, 6. Nonconductive gaskets 28, 30, 32, 34 provide seals and electrical insulation between the several components of the fuel cell stack 2.

Each of the MEAs 4, 6 are disposed between gas permeable conductive materials known as gas diffusion media 36, 38, 40, 42. The gas diffusion media 36, 38, 40, 42 can include carbon or graphite diffusion paper. The gas diffusion media 36, 38, 40, 42 can contact the MEAs 4, 6, with each of the anode layer and the cathode layer contacting an associated one of the gas diffusion media 36, 38, 40, 42. The end contact units 16, 18 contact the gas diffusion media 36, 42 respectively. The bipolar plate assembly 8, 10 contacts the gas diffusion media 38 on the anode face of MEA 4 (configured to accept hydrogen-bearing reactant) and also contacts gas diffusion medium 40 on the cathode face of MEA 6 (configured to accept oxygen-bearing reactant). Oxygen can be supplied to the cathode side of the fuel cell stack 2 from storage tank 48, for example, via an appropriate supply conduit 44. Hydrogen can be supplied to the anode side of the fuel cell from a storage tank 50, for example, via an appropriate supply conduit 46. Alternatively, ambient air can be supplied to the cathode side as an oxygen source and hydrogen to the anode from a methanol or gasoline reformer, and the like. Exhaust conduits (not shown) for both the anode and cathode sides of the MEAs 4, 6 are also provided. Additional conduits 52, 54, 56 are provided for supplying a coolant fluid to the bipolar plate assembly 8, 10 and the end contact elements 16, 18. Appropriate conduits for exhausting coolant from the bipolar plate assembly 8, 10 and end contact elements 16, 18 are also provided (not shown).

With reference now to FIGS. 2-3, the MEA 4 of one of the fuel cells of the fuel cell stack 2 is shown in greater detail, where an anode layer 58 and a cathode layer 60 are separated by a membrane 62. Each of the anode layer 58 and the cathode layer 60 can include a catalyst, such as particles of platinum (Pt) dispersed on a high-surface-area carbon support to provide a supported platinum catalyst 64. However, other catalysts, including one or more noble metals, can also be used in the anode and cathode layers 58, 60. The supported platinum catalyst 64 can be mixed with an ion-conducting polymer (ionomer). The anode layer 58 enables hydrogen molecules to dissociate into protons and electrons and can include hydrogen bronzes 66 interspersed therein. The cathode catalyst layer 60 can enable oxygen reduction by reacting with the protons generated by the anode, producing water. The ionomer mixed into the catalyst layers 58, 60 allows the protons to travel through these layers. The anode layer 58 can be devoid of ruthenium (Ru) to obviate Ru dissolution and subsequent crossover from the anode layer 58 to the cathode layer 60, for example, which can negatively impact the durability and longevity of the fuel cell 3 over time.

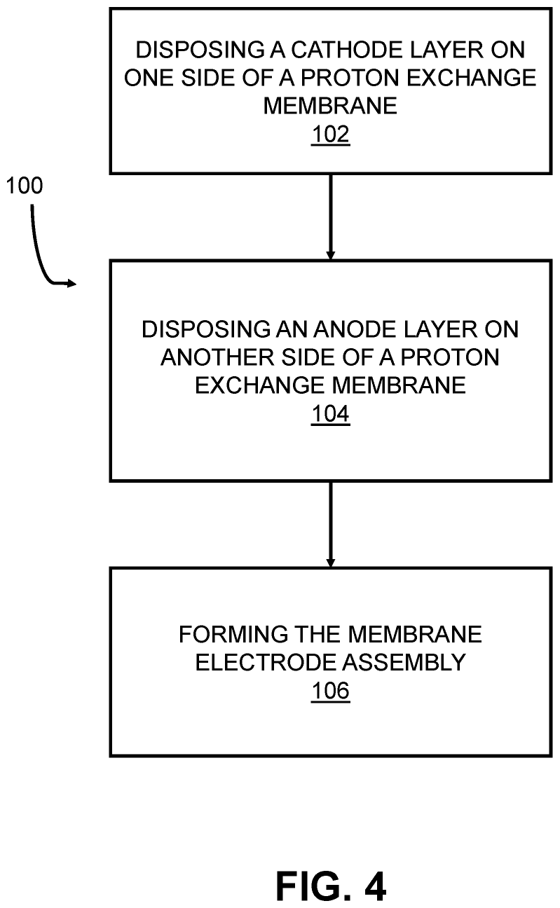

With reference to the method of forming an MEA with the present technology 100, as shown in FIG. 4, the steps include disposing a cathode layer on one side of a proton exchange membrane 102, and disposing an anode layer on another side of the proton exchange membrane 104, the anode layer including a hydrogen bronze, thereby forming the MEA 106.

It should be appreciated that the present disclosure further includes a vehicle such as an automobile, truck, tractor, aircraft, watercraft or the like having a fuel cell with a membrane electrode assembly as described hereinabove.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A membrane electrode assembly, comprising:
a cathode layer;
an anode layer, the anode layer including a hydrogen bronze; and
a proton exchange membrane disposed between the cathode layer and the anode layer.

2. The membrane electrode assembly according to claim 1, wherein the anode layer is free of ruthenium.

3. The membrane electrode assembly according to claim 1, wherein the anode layer includes a Pt/C catalyst.

4. The membrane electrode assembly according to claim 1, wherein the hydrogen bronze includes a metal oxide selected from a group consisting of niobium oxide, molybdenum oxide, tungsten oxide, and combinations thereof.

5. The membrane electrode assembly according to claim 1, wherein the hydrogen bronze includes niobium oxide.

6. The membrane electrode assembly according to claim 1, wherein the hydrogen bronze includes molybdenum oxide.

7. The membrane electrode assembly according to claim 1, wherein the hydrogen bronze includes tungsten oxide.

8. The membrane electrode assembly according to claim 1, wherein the hydrogen bronze includes a member selected from a group consisting of Pt/C—H—Nb₂O₅, Pt/C—H—-MoO₃, Pt/C—H—WO₃, and combinations thereof.

9. The membrane electrode assembly according to claim 1, wherein the hydrogen bronze includes Pt/C—H—Nb₂O₅.

10. The membrane electrode assembly according to claim 1, wherein the hydrogen bronze includes Pt/C—H—MoO₃.

11. The membrane electrode assembly according to claim 1, wherein the hydrogen bronze includes Pt/C—H—WO₃.

12. A fuel cell comprising a membrane electrode assembly according to claim 1.

13. A fuel stack comprising a membrane electrode assembly according to claim 1.

14. A vehicle comprising a fuel cell including a membrane electrode assembly according to claim 1.

15. A method of making a membrane electrode assembly, comprising:
disposing a cathode layer on one side of a proton exchange membrane; and
disposing an anode layer on another side of the proton exchange membrane, the anode layer including a hydrogen bronze.

16. The method according to claim 15, wherein the anode layer is free of ruthenium.

17. The method according to claim 15, wherein the hydrogen bronze includes a metal oxide selected from a group consisting of niobium oxide, molybdenum oxide, tungsten oxide, and combinations thereof.

18. The method according to claim 15, wherein the hydrogen bronze includes a member selected from a group consisting of Pt/C—H—Nb₂O₅, Pt/C—H—MoO₃, Pt/C—H—WO₃, and combinations thereof.

19. The method according to claim 15, wherein the anode layer is formed from a composition including an ionomer, platinum disposed on a high-surface-area carbon support (Pt/C), and the hydrogen bronze, the hydrogen bronze including a member selected from a group consisting of niobium oxide, molybdenum oxide, tungsten oxide, and combinations thereof.

20. The method according to claim 15, wherein the anode layer is formed from a composition including an ionomer, platinum disposed on a high-surface-area carbon support (Pt/C) impregnated with the hydrogen bronze, the high-surface-area carbon support (Pt/C) impregnated with the hydrogen bronze including a member selected from a group consisting of Pt/C—H—Nb₂O₅, Pt/C—H—MoO₃, Pt/C—H—WO₃, and combinations thereof.
